(19) United States
(12) Patent Application Publication
(10) Pub. No.: US 2026/0245752 A1
(43) Pub. Date: Aug. 20, 2026

(54) CALANDRIA NUCLEAR CORE ASSEMBLY AND METHOD OF ASSEMBLING A NUCLEAR MODERATOR CORE SYSTEM

(71) Applicant: TERRESTRIAL ENERGY, INC., Oakville (CA)

(72) Inventors: David LEBLANC, Ottawa, Ontario (CA); Ronald C. ROBINSON, Oakville, Ontario (CA)

(73) Assignee: TERRESTRIAL ENERGY, INC., Oakville, ON (CA)

(21) Appl. No.: 19/518,576

(22) PCT Filed: May 9, 2023
(86) PCT No.: PCT/CA2023/050632

§ 371 Date: Mar. 11, 2026

Related U.S. Application Data
(60) Provisional application No. 63/339,740, filed on May 9, 2022.

(51) Int. Cl. G21C 5/14; G21C 1/22; G21C 5/12; G21C 21/00

(52) U.S. Cl. CPC G21C 5/14; G21C 1/22; G21C 5/12; G21C 21/00

(57) ABSTRACT

A calandria-shaped nuclear reactor core is provided. The core has an annular body with covers at both ends. The core also has a plurality of tubes traversing the annular body and the covers. A neutron moderator material is located in the annular body between the tubes and the covers. Each tube hermetically seals an inside of the tube from the volume defined by the annular body, the covers and an outside of the tubes. The structural integrity of the reactor core may be provided by the annular body, the covers and the tubes when the materials of which they are made are sufficiently strong and thick. Alternatively, the moderator material itself can contribute to the structural integrity of the reactor core when the materials of which the reactor core is made are assembled to conform, at least in part, to an outside of the moderator material.

### FIELD

The present disclosure relates generally to nuclear reactors. More particularly, the present disclosure relates to molten salt nuclear reactors.

### BACKGROUND

Molten salt nuclear reactors (MSRs), being liquid-fueled systems and able to respond passively or inherently, have numerous advantages. They have been proposed under two broad families: fast spectrum designs, which lack any added moderator, or epithermal/thermal designs, which employ a moderator within the core.

Fast spectrum designs offer significant future potential as, in principle at least, reactor core designs can be as simple as comprising a tank that holds the liquid fuel salt and that offers some improved neutronic parameters that favor breeding operations. However, these designs have several drawbacks. Lacking any moderator, these systems require either high assay Low Enriched Uranium (LEU), typically having 10% to 19.9% ²³⁵U for startup, or plutonium, neither of which are commercially available. Although the needs for makeup fuel can be low or even non-existent for breeder versions of reactors, startup fissile loads typically need to be quite high and require efforts to limit the volume of primary fuel salt, as the fissile density within the liquid is far higher. These requirements for high loading and high enrichment also mean that out-of-core-critical concerns are heightened and must be carefully guarded against. The need for a low salt volume also means that there is very low thermal inertia and that systems for decay heat removal must be relatively fast acting. Finally, operational experience is completely absent for these designs.

Thermal designs of MSRs require a moderator within the core and offer many benefits. Standard assay (<5% ²³⁵U) LEU can be employed throughout the fueling cycle (from startup to makeup) in many cases and even when fuel salt processing is avoided for commercial simplicity. Fissile density in the fuel salt is far lower, and a much larger fuel salt volume per MWₜₕₑᵣₘₐₗ is typically employed. The added thermal inertia of the moderator aids significantly in situations such as complete loss of power, as decay heat raises the overall temperature quite slowly, giving time for simple passive techniques for ultimate decay heat removal. The use of the moderator and low enrichment within the fuel salt means that out-of-core criticality of the fuel salt is virtually eliminated.

Graphite has traditionally been the proposed moderating material for MSRs, and its utility was demonstrated in the Molten-Salt Reactor Experiment at the Oak Ridge National Laboratory of the 1960s. Graphite was especially favored in early breeder MSR development because it could be used without cladding and enabled the highest possible breeding ratios. As early development was focused towards breeder versions of reactors, the lack of cladding or structural material was of high interest.

Putting graphite in direct contact with the fuel salt results in a great many advantages but comes with significant challenges. A first challenge is that, under neutron irradiation, graphite initially tends to shrink modestly (~3 to 6% vol) and then begins to expand. Acceptable reactor use is limited to when graphite has returned to its original volume or just beyond. Two underappreciated consequences of the changes are that, with time, the fraction of fuel salt within the core can vary and the reactor physics coefficients can be affected. Special interlocking techniques and/or other external support mechanisms can be employed to counter fuel salt fraction changes. A second challenge is to ensure that fuel salt does not penetrate into the bulk of the graphite, which would cause unacceptable operational issues. It is also best, if possible, to limit fission gases such as xenon from entering the graphite, although this is less important than liquid penetration. The routes to achieve this are to employ only ultra-fine grain graphite with extremely small pore sizes (approximately 1 micron to block liquid entry but not gas) or to look at coatings, treatments or cladding options to help seal the graphite. Ultra-fine grain graphite with acceptable pore sizes is commercially available but is expensive and is typically only available in relatively small billet sizes (at least in one dimension) because of fabrication issues related to gas release during graphitization. A third challenge is the chemistry differences that arise from the salt contacting the graphite. This can limit the level of redox potential employed to prevent corrosion.

Many treatments have been attempted or proposed to create acceptable MSR graphite in terms of liquid penetration. The simplest route is to add steps for resin impregnation and re-graphitization to fill pores and reduce pore diameter. This was done to the graphite employed in the 1960s Molten-Salt Reactor Experiment but has limitations, often in the depth of penetration possible or in possible cracking as gasses from the resin impregnant escape. Many surface treatments have been attempted, such as applying pyrolytic coatings or silicon carbide impregnation. Results have been mixed, with the main concern being ablation of the produced surfaces during irradiation and subsequent dimensional changes.

Many coating treatments have been investigated; for example, chemical vapor deposition of metals such as molybdenum. Early work at the Oak Ridge National Laboratory suggested coating each individual graphite element in this way. Limited success has been seen. A reason for choosing molybdenum has been its similar coefficient of thermal expansion to graphite. However, graphite's expansion coefficient changes significantly with irradiation, and ablation or delamination of any applied surfaces would again be a significant challenge and require a very long testing regimen.

Given the challenges surrounding unclad graphite and attempted coatings, other moderator materials have been investigated. All of these materials have needed significant cladding because they would see rapid corrosion under contact with the molten salt and coating techniques would see many of the same challenges mentioned for graphite. The first MSR, the Aircraft Reactor Experiment of 1954, used beryllium oxide encapsulated in steel as the moderator. Although beryllium metal or oxide sees significant use in smaller test reactors, its use as a bulk moderator in power-producing nuclear reactors is difficult to consider given the large amounts of radioactive tritium that would be produced. Much of the radioactive tritium could remain trapped within the moderator and present a risk of release during a temperature transient. Solid beryllium compounds also see significant dimensional instability with irradiation as well, as they experience significant swelling. Zirconium hydride with cladding has also been proposed. The need for an equilibrium of hydrogen content in cover gas and metal matrix at high temperature makes such systems extremely challenging. Also, both beryllium compounds and zirconium hydride are far more expensive than even the costliest ultra-fine grain graphite. It should also be noted that compactness is often cited as a benefit of hydrogen-based moderators. However, thermal hydraulic limitations impose power density limits, and increased power density comes at the price of a loss of thermal inertia, which is needed to provide buffer time in response to loss-of-cooling incidents. This is important because decay heat can initially be as large as 7% of full power but declines quickly to smaller values of 1% or lower. Lower power density and large thermal inertia thus become an advantage to decay heat cooling scenarios.

Liquid-based moderators have been proposed, molten NaOH for example, but the stability of liquids at high temperature and high radiation fields is very challenging, as would be any chemical interaction with cladding material.

Thus, graphite is still advantageous for use as a moderator material, even when used with a true cladding material, i.e., one with its own structural integrity. Any use of cladding, however, may immediately lead to large increases in neutron absorptions, a lowering of fuel economy and a rising need for enrichment, perhaps beyond standard assay 5% LEU. Among cladding candidates that have a low absorption cross section and that are frequently cited are silicon carbide composites. These promising but challenging candidates require significant advances in fabrication techniques to meet the needs of full core structures and have many remaining uncertainties in terms of chemical stability when contacting molten salts. Alternatively, metal alloy candidates usually have either too high a neutron cross section or are incompatible with fluoride fuel salts—for example, zirconium would experience excessive corrosion. The main metallic choices with reasonable salt compatibility are iron-based steel alloys such as 316 and 304, nickel-based alloys such as Alloy N, and molybdenum or TZM. These candidates have similar cross sections for thermal neutron absorption, with 316 steel and molybdenum at around 2.6 barns, and nickel at around 4.5 barns. Each metal cladding, especially the nickel alloys, would also have challenges with excess neutron irradiation exposure producing helium but, if limited to similar fluences expected for graphite exposure, would remain potentially viable cladding candidates. Regardless of cladding choice, to meet the challenges to structural integrity brought by corrosion and irradiation effects, the cladding will require a minimum thickness.

Structural integrity, within the scope of the present disclosure, is to be understood as meaning the capability of a structure to support a load, including the structure's weight or hydrostatic pressure, without breaking.

Another major advantage of fully cladding the graphite or other bulk moderator in MSR systems is in keeping the moderator completely free of fission products. In a truly clad system, only the fission product tritium would be able to pass into the graphite. This would enable far more attractive decommission operations of spent bulk moderator. Studies have been performed on recycling used nuclear graphite for re-fabrication into new graphite elements by grinding down the used graphite into the starting feed stock for the graphitization process (which replaces the calcined coal pitch or petroleum coke that is usually used in fabrication, ORNL/TM-2010/00169). Such beneficial recycling operations would be far more complex and costlier for normal MSR graphite, which would contain very small amounts of all fission products that recoil out of the salt during fission and significant amounts of noble gas daughter products such as the cesium that can come from the entry and subsequent decay of Xenon.

Prior art has proposed cladding moderators for use in MSR with either silicon carbide or alkali hydroxides but have not addressed the overall structural integrity of the moderator plus cladding core. For example, forces due to differential thermal expansion, moderator dimensional stability and seismic loads in an overall system involving moderator.

Prior art directed to another class of nuclear reactor has proposed a calandria arrangement of graphite within a metal calandria to form a sodium-cooled, graphite-moderated reactor (U.S. Pat. No. 3,121,052). The calandria form comprises a cylindrical vessel submerged in a sodium pool and traversed by tubes. Fuel elements are positioned in the tubes through which sodium circulates to cool the reactor. Sodium leaked from the sodium pool into the vessel may be directed to an annulus formed between a liner of graphite through holes and process tubes positioned in the through holes. This prior art was proposed as an improvement for the individually clad graphite elements that had been employed in the 20 MWₜₕₑᵣₘₐₗ 1957 Sodium Reactor Experiment, which used graphite clad in zirconium metal. Designing the cladding to follow a calandria form provides many advantages, such as minimizing the amount of metal cladding within the core, but also brings a need for expansion bellows on each calandria tube that connect with the top and bottom plates. Following this design, zirconium metals and alloys are possible for use with liquid sodium. The design, however, does not address the overall needs of a structurally sound and seismically qualified modern core structure that can accommodate the changing dimensions of nuclear graphite, which will at first shrink and thus challenge the integrity of the overall structure.

Therefore, innovation in cladding plus moderator combinations that would simultaneously minimize the amount of cladding material within the high-flux areas of the core while providing overall structural rigidity to the core is desirable.

### SUMMARY

The present disclosure provides a calandria that houses a nuclear reactor core, which has a moderator made of a plurality of unclad neutron moderator elements. The unclad neutron moderator elements define a plurality of apertures traversed by a plurality of tubes that can carry a molten fuel salt. The tubes are impermeable to the molten fuel salt in that the tubes do not allow leakage of the molten fuel salt into the neutron moderator.

In a first aspect, there is provided a nuclear reactor core that comprises an annular body (AB) defining a first end and an opposite second end, a first cover covering the first end and defining a first plurality of through apertures, and a second cover covering the second end and defining a second plurality of through apertures. The nuclear reactor core also comprises a plurality of tubes extending from the first plurality of through apertures to the second plurality of through apertures of the second cover. Each tube of the plurality of tubes connects a through aperture of the first plurality of through apertures to a respective through aperture of the second plurality of through apertures. Each tube of the plurality of tubes hermetically seals an inside volume of each tube from a volume delimited by an outside of each tube of the plurality of tubes, the first cover, the second cover and the annular body, each tube of the plurality of tubes configured to convey a molten fuel salt. The nuclear reactor core also comprises neutron moderator material located in the AB between the first cover, the second cover and the plurality of tubes.

In some embodiments, the neutron moderator material defines a plurality of through holes and each tube of the plurality of tubes extends through a respective through hole of the plurality of through holes. The neutron moderator material may be in a form of a plurality of solid bulk neutron moderator elements (NMEs). Each NME of the plurality of NMEs may define at least one through hole extending from a first end of the respective NME to a second end of the respective NME, and each tube of the plurality of tubes may extend through a respective one of the at least one through hole.

In some embodiments, each NME of the plurality of NMEs defines one or more through openings distinct and spaced apart from the plurality of through holes and each of the one or more through openings is free of any tube of the plurality of tubes extending therethrough. Each of the one or more through openings may be formed equidistant between two or more through holes. Each through opening of the one or more through openings may be at least partially filled with a particle bed of neutron moderator material.

In some embodiments, each through opening of the one or more through openings may be at least partially filled with another moderator material different from the neutron moderator material of the plurality of NMEs. The particle bed of neutron moderator material may include at least one of a powder, pebbles, flakes and grindings of the neutron moderator material. The particle bed of the other neutron moderator material may include at least one of a powder, pebbles, flakes and grindings of the other neutron moderator material.

In some embodiments, the neutron moderator material may be in a form of a particle bed. The particle bed may include at least one of a powder, pebbles, flakes and grindings of the neutron moderator material.

In some embodiments, the neutron moderator material may be in a form of a liquid and the liquid may be a fluoride salt containing beryllium fluoride.

In some embodiments, the volume delimited by an outside of each tube of the plurality of tubes, the first cover, the second cover and the annular body is positively pressurized.

In some embodiments, the annular body (AB) defines an AB wall with an AB wall thickness, the first cover has a first cover thickness, the second cover has a second cover thickness, the plurality of tubes have a tube thickness, and the AB wall thickness, the first cover thickness, the second cover thickness and the tube thickness are selected for the AB, the first cover, the second cover and the tubes to conform at least partially to the neutron moderator material when the volume delimited by the outside of each tube of the plurality of tubes, the first cover, the second cover and the annular body is negatively pressurized to a threshold pressure.

In some embodiments, the AB wall has a wall with an AB wall thickness, the first cover has a first cover thickness, the second cover has a second cover thickness, the plurality of tubes have a tube thickness, and the AB wall thickness, the first cover thickness, the second cover thickness and the tube thickness are selected for the AB, the first cover, the second cover and the tubes to provide structural integrity to the nuclear reactor core.

In some embodiments, the tube thickness is comprised between 0.2 and 1 mm.

In some embodiments, the tube thickness is comprised between 0.5 and 3 mm.

In some embodiments, each of the tubes of the plurality of tubes comprises bellows configured to expand and contract.

In some embodiments, the nuclear reactor core may further comprise a plurality of sleeves, each sleeve housing and supporting a respective tube of the plurality of tubes. The sleeve may made of material that as a neutron absorption cross section smaller than 1 barn. The material is selected from a group consisting of zirconium metal, zirconium alloys, silicon carbide, carbon-based composites, and beryllium metal.

In some embodiments, the neutron moderator material is graphite.

In some embodiments, the particle bed of the other neutron moderator material is made from beryllium oxide.

In some embodiments, the AB, the first cover, the second cover and the plurality of tubes are made of a material selected from a group consisting of stainless steel, molybdenum, TZM, Alloy N, silicon carbide and carbon-based composites.

In a further aspect, there is provided a calandria nuclear core assembly that comprises a plurality of neutron moderator elements, each neutron moderator element (NME) having a first end and a second end, each NME defining a through hole extending from the first end to the second end, along an entire length of the NME; a plurality of tubes, each tube being located in a respective NME, each tube having a first end portion and a second end portion, the first end portion protruding out of the first end of the respective NME, the second end portion protruding out of the second end of the respective NME; a first plate defining a respective plurality of through apertures; a second plate defining a respective plurality of through apertures. The first end portion of each tube is inserted into a respective through aperture of the first plate. The second end portion of each tube is inserted into a respective through aperture of the second plate. And a peripheral wall surrounds the NMEs and connects the first plate to the second plate. Any space between an outside of the first end portion of the tubes and the respective through aperture of the first plate is sealed. Any space between an outside of the second end portion of the tubes and the respective through aperture of the second plate is sealed. The peripheral wall forms a seal with the first plate and with the second plate.

In some embodiments, each tube has an outside portion and a volume defined by the outside of the tubes, the first plate, the second plate and the peripheral wall is negatively pressurized.

In a further aspect, there is provided a method of assembling a nuclear moderator core system. The method comprises providing a plurality of neutron moderator elements, each neutron moderator element (NME) defining a through hole, each NME having a first end and a second end, the second end being opposite the first end, each through hole extending between a respective first end and second end; installing a plurality of tubes in the plurality of NMEs by having each tube pass through a respective through hole defined by a NME, each tube of the plurality of tubes having a first end and a second end, wherein when the plurality of tubes are installed, each first end of a tube extends out of a respective first end of a respective NME and each second end of the tube extends out of a respective second end of the respective NME; inserting the plurality of first ends of tubes into through apertures of a first end plate and securing the plurality of first ends of the tubes to the first end plate; inserting the plurality of second ends of tubes into through apertures of a second end plate and securing the plurality of second ends of the tubes to the second end plate; connecting the first end plate to the second end plate with a peripheral wall that surrounds the plurality of NMEs, the peripheral wall, the first end plate, the second end plate and the outer surface of the plurality of tubes defining an enclosed space; and applying a vacuum to the enclosed space to reduce a pressure in the enclosed space, a reduction in pressure to cause the first end plate, the second end plate and the tubes to squeeze against the plurality of NMEs.

The present disclosure teaches the integration of fuel channel tubes into a form of calandria inside which the neutron moderator remains separated from the fuel salt. The overall structure is made up of a bottom plate with appropriate openings for connection to tubes that form an inner boundary to the fuel salt. This bottom plate being connected, for example welded, to a cylindrical peripheral wall section of the same material, for example 316 stainless steel (SS), which forms the outer boundary of the reactor core. Into this, neutron moderator elements, with pre-drilled hole patterns are placed and fill the inner structure. A similar top plate with openings for channel tubes is connected to the side wall. Through the openings in the top and bottom plates, which align with through holes in the stacked moderator, thin-walled tubing is lowered into the structure and connected to the top and bottom plate, for example by cold rolled joining techniques.

### BRIEF DESCRIPTION OF THE DRAWINGS

Embodiments of the present disclosure will now be described, by way of example only, with reference to the attached Figures.

FIG. 1 shows an embodiment of a calandria nuclear reactor core in accordance with the present disclosure.

FIG. 2 shows the bottom plate of the calandria nuclear reactor core of FIG. 1.

FIG. 3 shows a cutaway view of the bottom plate of FIGS. 1 and 2 to which the peripheral wall has been fitted in the groove of the bottom plate.

FIG. 4 shows the cutaway view of FIG. 3 with a first layer moderator logs placed on the bottom plate.

FIG. 5 shows the cutaway view of FIG. 4 with a second layer of moderator logs placed on the first layer.

FIG. 6 shows the cutaway view of FIG. 5 with a top plate placed atop the second layer of moderator logs.

FIG. 7A shows the same cutaway view as in FIG. 6 but with tubes inserted in through apertures of the top plate, the through holes of the logs and the through apertures of the bottom plate.

FIG. 7B shows an embodiment of bellows structures defined by tubes.

FIG. 8 shows a block diagram of the calandria of FIG. 7, coupled to a heat exchanger.

FIG. 9 shows a top view of an example of a cross section of a moderator log in accordance with the present disclosure.

FIG. 10 shows a top view of another example of a cross section of a moderator log in accordance with the present disclosure.

FIG. 11 shows a top, cross-sectional view of a tube spaced apart from the moderator material of a log, by a sleeve 70, in accordance with an embodiment of the present disclosure.

FIG. 12 shows a bottom head assembly that can be secured to a calandria in accordance with the present disclosure.

FIG. 13 shows the bottom head assembly of FIG. 12 secured to a calandria in accordance with the present disclosure.

FIG. 14 shows a chimney connected to the calandria and bottom head assembly of FIG. 13, in accordance with the present disclosure.

FIG. 15 shows a cutaway view of the calandria, surrounded by reactor wall 63, in accordance with the present disclosure.

FIG. 16 shows a flowchart of an embodiment of a method according to the present disclosure.

FIGS. 17, 18 and 19 show a top cross-sectional view of the moderators logs for hexagonal cross section logs (FIGS. 17 and 18) and for square cross section logs (FIG. 19).

FIG. 20 shows a plot of neutron cross sections (in barns, b) versus neutron energy (eV) and shows that direct tritium production (n,t) is only appreciable for the highest fission energies.

### DETAILED DESCRIPTION

The present disclosure provides an improved Molten Salt Nuclear Reactor Core (referred to as the reactor core or reactor herein). The present disclosure also provides a method of assembling the reactor core. This involves forming a calandria-type envelope, which includes numerous tubes and a peripheral wall sealed to a top plate and bottom plate and can contain neutron moderator material (moderator). The neutron moderator material may, for example, be graphite. The top and bottom plates (covers) are connected by an outer cylinder (an annular body), thus forming a sealed volume (an inside volume) in which the neutron moderator resides and is separated from fuel salt that may flow within said tubes. The reactor core of the present disclosure has greater structural integrity than prior art reactor cores.

In some embodiments, the structural integrity is provided by the calandria itself. In these embodiments, the tubes provide moderately rigid support to the top and bottom plates by being thicker. When connected with the top and bottom plates, by the outer cylinder wall, the whole assembly provides overall structural integrity that allows free movement of the neutron moderator during any dimensional change of the neutron moderator due to irradiation. In these embodiments, as an example, the tube thickness may be between 0.5 and 3 mm when the tubes are constructed from stainless steel.

In other embodiments, the inherent structural integrity of the neutron moderator can be called upon. In these embodiments, thinner-walled tubes, thinner plates and a thinner-walled outer cylinder can permit the calandria material to naturally conform, either plastically or elastically, to the neutron moderator surface, possibly aided by applying a partial vacuum (a threshold pressure) to the calandria volume housing the graphite in a method akin to shrink wrapping. The partial vacuum may comprise any absolute pressure between atmospheric pressure and vacuum, such as, for example, 0.1 bar. This will cause the calandria volume to become negatively pressurized with respect to its immediate surroundings. In such an embodiment, any change in neutron moderator dimension due to irradiation would be accommodated by movement and/or deformation of the thinner-walled calandria material. In these embodiments, as an example, the tube thickness may be between 0.2 and 1 mm when the tubes are constructed from stainless steel.

In some embodiments, the structural integrity is provided by the calandria having multiple solid bulk neutron moderator elements located in a container and traversed by multiple tubes, which are configured to accommodate flowing molten fuel salt. The thickness of the materials of which the container is made, and the hydrostatic pressure difference between the outside and the inside of the container, are such that the container can conform to the neutron moderator elements and the neutron moderator elements can become pressed against each other by the container. In other embodiments, the structural integrity is provided by the container having appropriately thick container walls that contribute to supporting the assembly.

In other embodiments, the structural integrity is provided by an inert gas that is pumped into the volume created by the tubes, top and bottom plates, and outer cylinder wall. In operation, the hydrostatic pressure and pumping pressure created by the surrounding fuel salt will press against the calandria assembly. An inert gas may be pumped into the calandria to counteract the hydrostatic pressure and support the calandria. Pumping a gas into the calandria volume will cause it to become positively pressurized with respect to its immediate surroundings.

The neutron moderator elements of the present disclosure may be logs, blocks or any other suitable polygonal volume. The neutron moderator elements will have at least one through hole (channel) for fuel salt to flow through but may have additional channels (through openings). The additional channels may be used as through holes for fuel salt or may be used for circulating a separate coolant or for additional neutron moderator material, as is discussed below. The channel and, if present, the additional channels extend from one end of the neutron moderator element to the opposite end thereof.

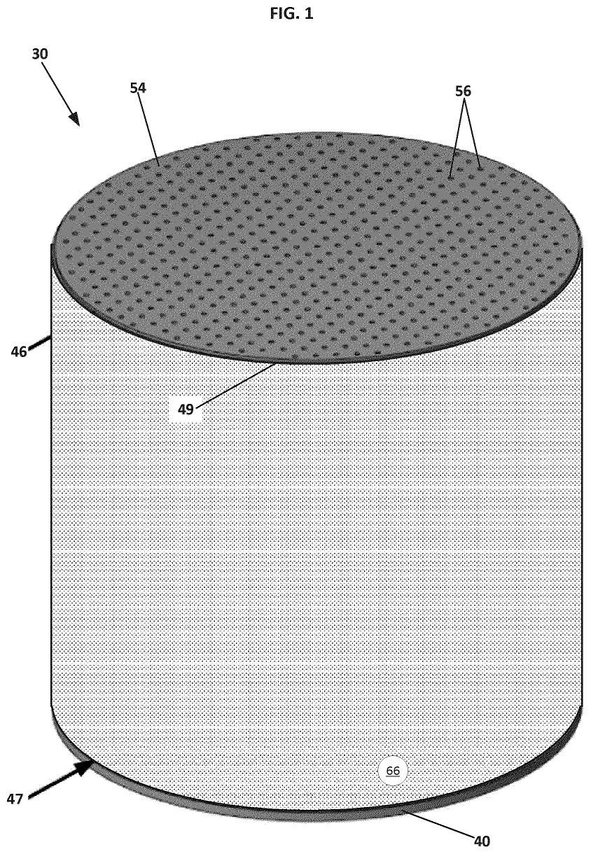

FIG. 1 shows an embodiment of a calandria nuclear core (calandria) 30 in accordance with the present disclosure. The calandria nuclear core 30 has a bottom plate 40, which defines through-apertures (not shown), a top plate 54, which defines through apertures 56, and a peripheral wall 46. FIG. 1, at reference numbers 47 and 49 also shows where the peripheral wall 46 joins the bottom plate 40 and the top plate 54. A vacuum port 66 can also be part of the calandria 30 and is discussed further below. A gas inlet valve can further accompany the vacuum port 66. The peripheral wall 46, the top plate 54 and the bottom plates 40 can be made of any suitable material that can adequately resist corrosion (i.e., has adequate corrosion allowance), the corrosion being from contact with molten salts. Such materials include, for example, stainless steel as a preferred embodiment but also molybdenum, TZM, Alloy N, silicon carbide and other carbon-based composites. In some embodiments, the top plate 54 and the bottom plate 40 can have a thickness of about 1 inch. However, any other suitable thickness is to be considered within the scope of the present disclosure.

In the embodiment of FIG. 1, the bottom plate and the top plate are interconnected by, for example, ~500 tubes and may be interconnected by any other suitable number of tubes. The peripheral wall also interconnects the top plate to the bottom plate. In addition, the top plate may abut the top surface of neutron moderator logs and the bottom plate may abut the bottom surface of the neutron moderator logs. All these interconnections may contribute to the structural integrity of the reactor core.

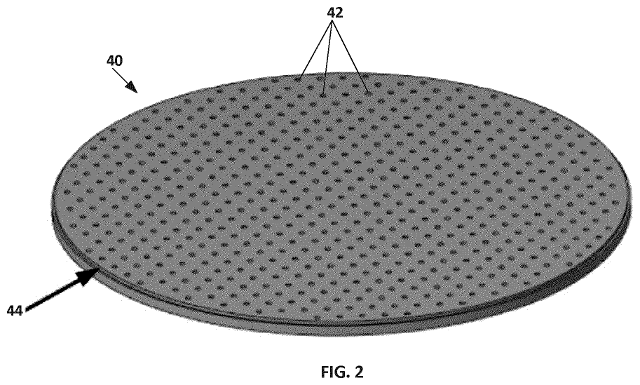

FIG. 2 shows an example of the bottom plate 40. The bottom plate 40 is disc shaped and defines a plurality of through apertures 42 sized to receive tubes, as is discussed further below. In the scope of the present proposal, the bottom plate 40 may alternatively have the shape of an ellipse, a rectangular, or any other suitable shape. The bottom plate 40, for example and if constructed from stainless steel, may have a thickness between 1 and 5 mm. The bottom plate 40 further defines a peripheral groove 44 configured to mate to the sidewall 46, which is discussed further below.

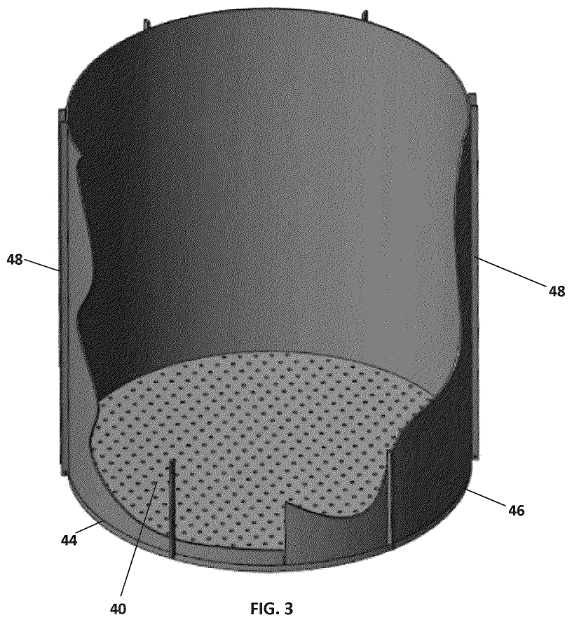

FIG. 3 show a cutaway view of the bottom plate 40 of FIG. 2 to which the peripheral wall 46 has been fitted in groove 44 of the bottom plate 40. The peripheral wall 46 can be secured to the bottom plate 40 through any suitable means such as, for example, electron beam welding, arc welding, etc. The peripheral wall 46 can have reinforcement ribs 48 secured thereto through any suitable means such as, for example, welding.

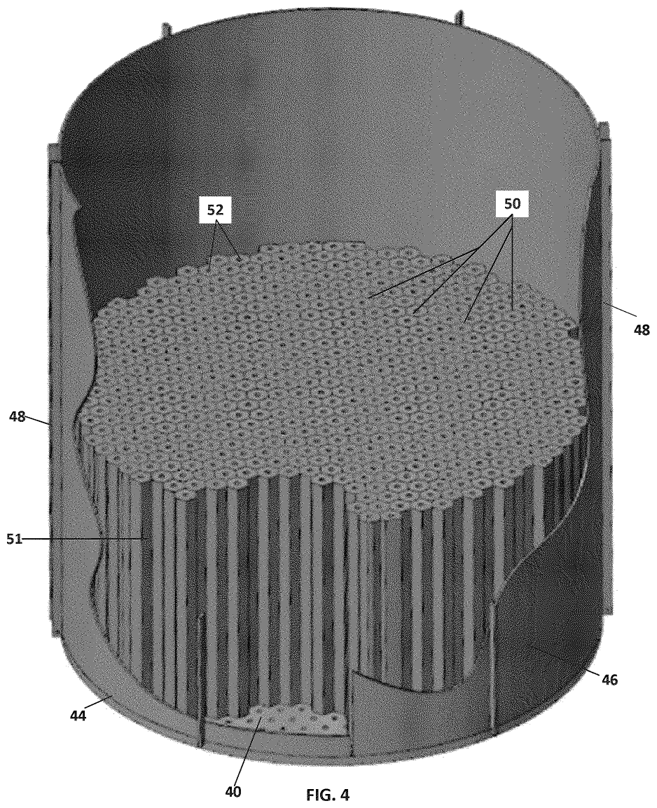

FIG. 4 show a cutaway view of the bottom plate 40 secured to the peripheral wall 46. In FIG. 4, a plurality of neutron moderator logs 50 are shown located on the bottom plate 40 and within the space defined by the peripheral wall 46. The plurality of neutron moderator logs 50 defines a first layer 51 of neutron moderator logs. Each of the logs 50 defines a through hole 52, which, when the neutron moderator logs are installed, is aligned with a through aperture of the bottom plate 40. The diameter of the through hole 52, the length of the through holes 52 and the number of through holes 52 depends on the desired fuel salt volume fraction. In some embodiments, the diameter of the through holes may be, for example, be between 2 and 8 cm. The number of through holes and the length of the moderator material will increase with the desired volume of the core which in turn is a function of the target power density and total power output. In some embodiments, the length may range from 1 to 6 meters and the number of channels may range from 100 to 500.

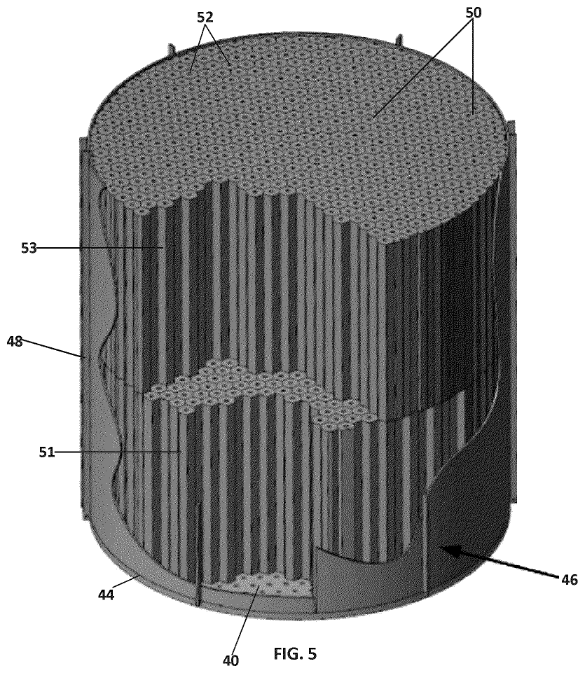

FIG. 5 shows the same cutaway view as shown in FIG. 4 but with a second layer 53 of a plurality of neutron moderator logs 50 placed on top of the first layer 51. The though holes 52 of the logs 50 in the second layer are aligned with the through holes 52 of the logs 50 in the first layer 51.

In the embodiment of FIG. 5, the neutron moderator logs 50 have a length shorter than the height of the peripheral wall 46 and a cross section that is hexagon shaped. This need not be the case. The neutron moderator logs 50 can be sized such that their length is about the height of the peripheral wall 46 and only a single layer of neutron moderator logs 50 is used. Further, in other embodiments, instead of having two layers of neutron moderators logs 50, there can be three layers or there can be any suitable number of layers of neutron moderator logs 50 to fill the calandria with neutron moderator logs 50 or neutron moderator material, such that, for example, the neutron moderator material extends from the bottom plate 40 to the top plate 54. Further, the hexagon-shaped cross section of the neutron moderator logs 50 may be substituted with any other suitable cross section shape within the scope of the present disclosure. For example, the neutron moderator logs could have a square cross section.

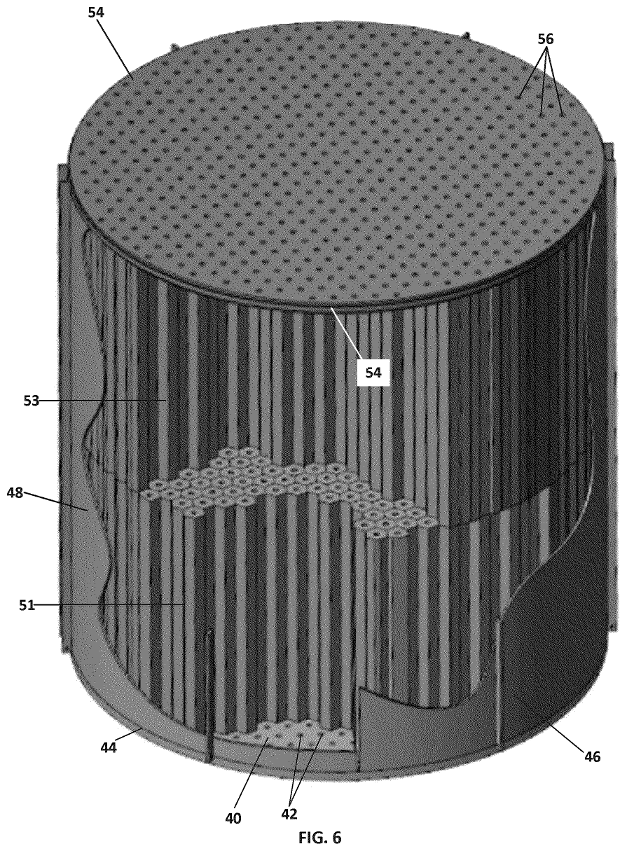

FIG. 6 is similar to FIG. 5 but includes the top plate 54 connected to the peripheral wall 46. The top plate 54 has a plurality of through apertures 56 configured for alignment with the through holes 52 of the neutron moderator logs 50 and with the through-apertures 42 defined by the bottom plate 40. Similar to the bottom plate 40, the top plate 54 can have a groove 58 (not shown) configured to mate to the sidewall 46 and can be disc shaped. In the scope of the present proposal, the top plate 54 may alternatively have the shape of an ellipse, a rectangular, or any other suitable shape. The top plate 54, for example, and if constructed from stainless steel, may have a thickness between 1 and 5 mm. The peripheral wall 46 can be secured to the top plate 54 through any suitable means such as electron beam welding, arc welding, etc.

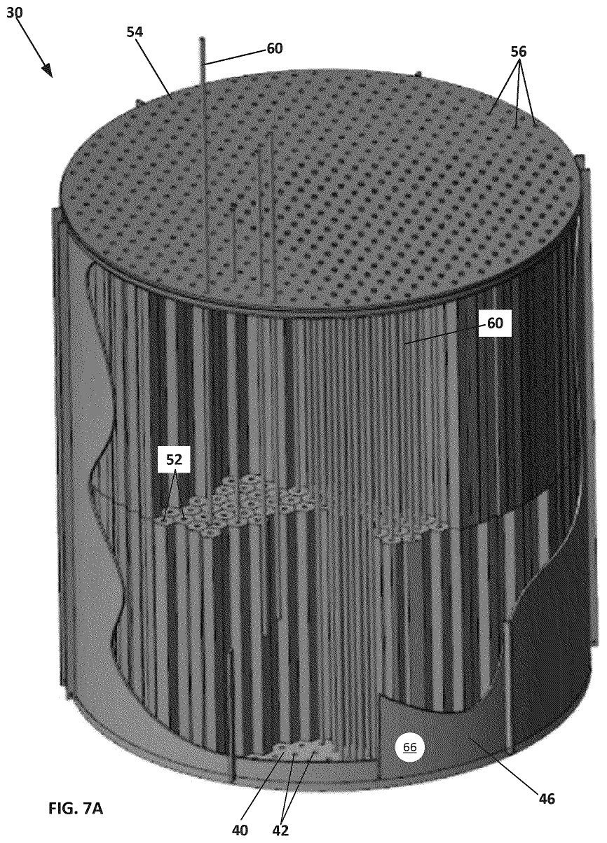

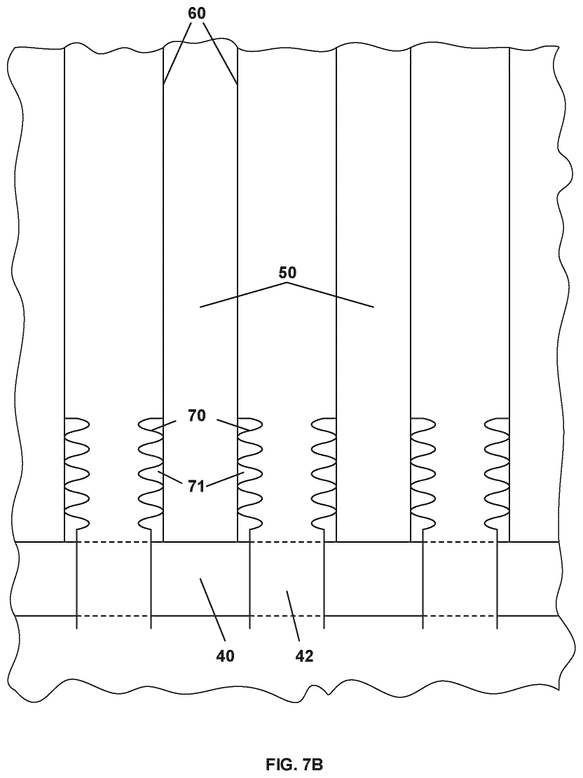

FIG. 7A shows the same cutaway view as in FIG. 6 but with tubes 60 inserted in through apertures 56 of the top plate 54, the through holes 52 of the neutron moderator logs 50 and the through apertures 42 of the bottom plate 40. The tubes 60 may protrude out of the calandria 30, beyond the top plate 54 and bottom plate 40. The diameter of the tubes 60 may be slightly smaller than the diameter of the through holes 52, such that a gap is created between the through holes 52 and the tubes 60 when the tubes 60 are inserted. This gap may, for example, be between 0 and 5 mm wide.

The tubes 60 are preferably thin but, some thickness is required for strength and some thickness is required for inevitable corrosion of the tubes 60 by molten salt. Limiting the thickness of the tubes 60 will minimize the parasitic neutron absorption, which would benefit the nuclear fuel efficiency and the required starting enrichment of fissile elements of the molten fuel salt. It is expected that thicknesses beyond 3 mm may result in an unacceptable increase in the lifetime fuel requirements of the reactor.

The tubes 60 may have bellow sections 70 (baffle sections) that are designed to account for differential thermal expansion between the tubes 60 and the neutron moderator logs 50 in which the tubes 60 are located. An example of bellow sections is shown in FIG. 7B. A gap 71 formed between the bellow section 70 and the neutron moderator element may be filled with an inert gas or be under a partial vacuum.

The tubes 60 can be made of any suitable material such as stainless steel, molybdenum, niobium, silicon carbide or other carbon composites.

The calandria 30 prevents molten salt from contacting the neutron moderator material without adding an unsuitable amount of metal in the core. The tubes 60 are spaced apart by a suitable distance, which is guided, at least in part, by the total amount of metal within the neutron moderator material, the desired fissile material enrichment, the neutron moderator lifetime and the structural strength of the core assembly. A typical tube spacing distance (i.e., the center-to-center distance) can be, in some embodiments, from 10 cm to 60 cm.

When all the through apertures 56 of the top plate 54, all the through apertures 42 of the bottom plate 40, and all the through holes 52 of the neutron moderator logs 50 have been fitted with a respective tube 60, the tubes 60 are secured to the top plate 56 and the bottom plate 40 through any suitable sealing means such as cold rolling sealing, welding, etc. Further, the peripheral wall 46 is secured and sealed to the top plate 56 and the bottom plate 40.

Any fluid circulating in the tubes 60 or on the outside of the peripheral wall 46, or at the junctions between the top plate 56 and bottom plate 40 with the peripheral wall 46 is prevented from becoming in contact with the neutron moderator logs 50.

The neutron moderator logs 50 are shown as being in contact with each other. This need not be the case. Having the neutron moderator logs 50 spaced from each other can enable the reactor core to accommodate the expansion of neutron moderator logs 50 with time. In addition, if the neutron moderator logs 50 are touching at the beginning of operation, they may pull away from each other as the neutron moderator material first contracts from neutron irradiation.

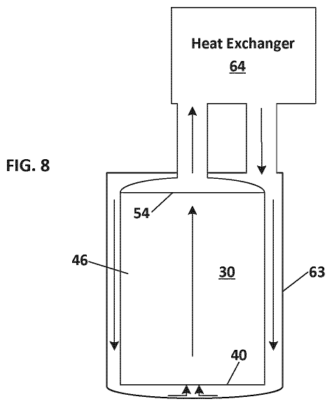

FIG. 8 shows a block diagram of the calandria 30 of FIG. 7A, coupled to a heat exchanger 64. Molten fuel salt exits the heat exchanger 64 at low temperature; flows downward, between the peripheral wall 46 of the calandria 30 and an outside wall 63 (wall of the reactor core vessel); enters the calandria 30 at the bottom of the calandria 30; proceeds into the tubes of the calandria 30; and flows upwards through the tubes of the calandria 30. As the molten fuel salt propagates upward in the calandria 30, nuclear fission of the fuel elements in the molten fuel salt occurs. This results in the molten salt increasing in temperature and the neutron moderator material increasing in temperature. The molten salt further increases in temperature by absorbing some of heat generated in the neutron moderator material. The molten fuel salt exits the calandria 30 at a high temperature and subsequently provides heat to the heat exchanger 64. Propagation of the molten fuel salt in the loop defined by the heat exchanger 64 and the calandria 30 can be convection driven or can be assisted by any suitable pumping mechanism. As will be understood by the skilled worker, in other embodiments, the circulation of the molten fuel salt in the calandria 30 can be effected, for example by a pump, in a direction opposite the direction indicated by the arrows in FIG. 8.

In a version of the embodiments shown in FIGS. 1-7A, the top plate 56 and the bottom plate 40 are purposely thin and, the thicknesses of the tubes 60 and of the peripheral wall 46 are kept small. The thicknesses of the top plate 56, bottom plate 40, tubes 60 and peripheral wall 46 are selected such that when a vacuum is applied, through the vacuum port 66 of FIG. 1, to the space comprised between the outside of the tubes 60, the top plate 56, the bottom plate 40 and the peripheral wall 46, the difference in pressure between the outside of the calandria and the inside of calandria will cause the top plate 56 to push down on the neutron moderator logs 50, the bottom plate 40 to push up against the neutron moderator logs 50, the peripheral wall 46 to push radially inwards against the neutron moderator logs 50 and, the tubes 60 to push radially outwards against the periphery of through holes 52 of the neutron moderator logs 50. As will be understood by the skilled worker, any suitable type of vacuum system can be connected to the calandria at vacuum port 66, to allow a vacuum to be applied to the calandria before sealing for the life of the calandria.

Further, in the calandria embodiments of FIGS. 1-7A and 7B and in other embodiments of the calandria, the tubes 60 and the through holes 52 are not bonded to each other. Rather, a relative movement of the tubes 60 with respect to the wall of the through holes is allowed to accommodate a difference in temperature expansion coefficients of the tubes 60 and the neutron moderator logs 50.

With the applied difference in pressure between the outside and the inside of the calandria, the neutron moderator logs 50 can become effectively pressure wrapped between the top plate 56, bottom plate 40, peripheral wall 46 and tubes 60. This allows for a structurally solid calandria unit that offers good protection to the tubes 60. This form of pressure wrapping of the neutron moderator, by the components of the calandria, may be advantageous when transporting the calandria and/or assembling the reactor. More importantly, the components of the calandria remain pressure wrapped during operation of the reactor when the neutron moderator may change dimensions and/or in response to seismic events.

In the present calandria embodiment, the fact that the thickness of the tubes 60 is small, causes less neutrons to be absorbed in wall of the tubes 60.

In another embodiment, the thicknesses of the top plate 54, the bottom plate 40, the peripheral wall 46 and the tubes 60 may not be sufficiently thin to allow the neutron moderator logs 50 to be pressure wrapped as in the calandria embodiment described above. Rather, the vacuum is applied to avoid excessive pressure in the calandria when the calandria is in operation at its design temperature (e.g., from room temperature at construction of the calandria to operating the calandria at 700° C. would add roughly 3 bars of pressure, thus pulling down to a ⅓ bar vacuum would produce a 1 bar pressure at 700° C.).

In the present embodiment, the overall structural integrity is now a function of various sections of metal. By welding a more substantially thick top plate and bottom plate to a substantially thicker side wall, the metal calandria itself enables overall structural integrity.

When a neutron moderator material, notably graphite, shrinks from neutron fluence exposure, it can pull away from top and bottom plate or slightly away from the walls of each calandria tube and the metal structure itself may stay rigid. As dimensional changes in the moderator would make very little net difference to the calandria through hole 52 diameter (channel size) due to its small starting dimension, the calandria tube material will remain partially supported by the surrounding graphite or other solid moderator.

In yet another embodiment, inert gas may be pumped into the calandria to support the top plate 54, bottom plate 40, peripheral wall 46 and tubes 60. This inert gas can be pumped to a pressure that would support the calandria in resisting the hydrostatic pressure and pumping pressure created by the fuel salt. This may allow for thinner tubes as it may allow pressure balancing between the fuel salt within the tube and a gas under pressure within the calandria.

In the embodiments disclosed herein, the neutron moderator material of which the neutron moderator elements are made can be graphite, or any other suitable material.

In the embodiments described above, the temperature of the moderator material will not be uniform. Rather, the temperature of the moderator material will be greater at regions that are mid-point between the tubes 60 that carry molten fuel salt than elsewhere in the moderator material. These regions can constitute localized maximum temperature points. Depending upon design and salt fraction, approximately 5to 6% of the energy of the fission process is deposited directly into graphite (when graphite is used as the neutron moderator material) and is mainly removed by the flow of the molten fuel salt (which also acts as a coolant salt for the neutron moderator material) in the tubes 60. As the bulk of graphite or other solid neutron moderator may be heated by a mix of neutron and gamma radiation, higher temperature can arise at the midpoint between channels (i.e., tubes 60). Graphite's useful lifetime is limited by net fast neutron fluence. The useful lifetime value diminishes with increasing temperature. Because the fast flux is highest at the edge of cooling channels (i.e., at the periphery of the tubes), which are nearest to the source of fast neutrons, the midpoint (between two channels) temperature needs to be substantially higher before it becomes the weak link in the graphite lifetime. There also exist advantages to using a larger spacing distance between tubes, but a larger spacing may be limited by the consequential increases in temperature at the localized maximum temperature points. Calandria tubes 60 can impede the flow of heat between the moderator and flowing salt and enhance this potential temperature-increase drawback.

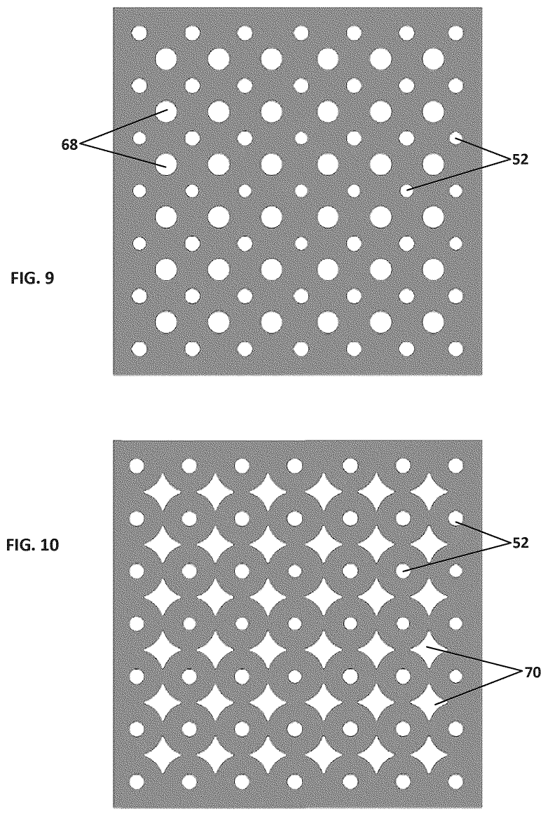

FIG. 9 shows a top view of an example of a neutron moderator log 50 of the present disclosure with a square cross section. FIG. 10 shows a top view of another example of a neutron moderator log 50 of the present disclosure with a square cross section. As shown in FIGS. 9 and 10, the neutron moderator log 50 has through holes 52 sized to receive tubes 60. In FIG. 9, the neutron moderator log 50 also has circular openings 68, and in FIG. 10, the neutron moderator log 50 has four concave sides (FCS) openings 70. The width of the circular openings 68 and FCS openings 70 may, for example, be between 1 and 10 cm. Arranging the neutron moderator elements in a square lattice as opposed to a hexagonal lattice can be useful, as a square lattice has more localized maximum temperature points that are more equally distant, which would be located at the circular openings 68 and the FCS openings 70, shown in FIGS. 9 and 10 respectively. The openings 68 and 70 prolong the net graphite lifetime by removing the hottest region. However, the openings 68 and 70 can increase neutron leakage from the nuclear reactor core.

In some embodiments, the circular openings 68 and FCS openings 70 can be filled with neutron moderator powder or neutron moderator pebbles or another suitable particle bed of neutron moderator. With graphite as the neutron moderator material, the graphite particle bed can be in any suitable form, such as, for example: natural graphite flakes, carbon black, ground graphite and graphite pebbles. As heat transfer is poorer in a powder or pebble bed, the central temperature within the particle bed will be very high. This means each particle of the graphite powder will exceed the traditional limit of neutron fluence much sooner than the surrounding matrix of bulk solid graphite, but such a powder or pebble bed can be allowed to expand or even break apart into finer particles. Such a particle bed may not have as high a density of the surrounding solid graphite, but if it occupies only a small fraction of the whole core, its presence would not significantly increase neutron leakage, when compared to a neutron moderator elements without openings. For example, some forms of flake, powder or pebble might be able to attain a higher density (up to 2.2 g/cc) than standard commercial graphite (1.7-1.9 g/cc) such that even a random particle bed of particles whose packing fraction is substantially below 100% will still have a substantially high density. Graphite flakes, being largely plate-like in shape, can attain a higher packing fraction upon compression.

In other embodiments, graphite powders or carbon black or another suitable graphite particulate could be used as a general filler material throughout the calandria, filling gaps between bulk graphite elements, between calandria tubes and graphite, and between bulk graphite elements and the outer wall and upper and lower calandria plate.

In a related embodiment, rather than having solid bulk neutron moderator elements, an entire matrix of particle bed, such as powder, flakes, or pebbles made of the neutron moderator material (e.g., graphite), can be used. The particle bed would suitably fill the space within the calandria. This would offer the distinct advantage of possibly eliminating neutron moderator lifetime issues altogether. Such a matrix would have free space for the neutron moderator material to expand and fracture without adverse effects to the supporting calandria. Such a particle bed would undoubtedly be a poorer conductor of heat, peak temperatures within the particle bed could be very high, and the turnaround time for the particle bed to reach its original volume after initial shrinkage due to fast neutron flux would be short, yet, a complete breakdown of the particles may be acceptable. However, such a particle bed of neutron moderator material would offer far less backup rigidity to the calandria tubes and outer metal structure. A related embodiment would be the use of a liquid neutron moderator material, such as, for example, beryllium fluoride, a fluoride salt containing beryllium fluoride, or molten sodium hydroxide.

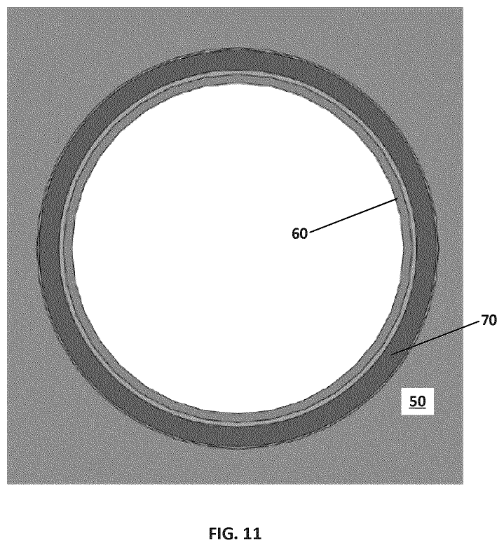

Additional embodiments may use metal or another structural material, i.e., a material that can contribute to the structural integrity of the calandria, to be a backup or sleeve that provides structural stability for the tubes 60. These materials would be of low neutron absorption cross section but may not need to be compatible with contacting molten salt. An example of the present embodiment is shown in FIG. 11, which shows a top view of a tube 60 spaced apart from the moderator material of a log 50, by a sleeve 70. The neutron absorption cross section may be, for example, less than 1 barn.

As an example, a sleeve 70 made of zirconium or one of its many low-swelling alloys, which would not be compatible with contacting the salt without being damaged, could provide a solid backing for a thin tube of stainless steel or molybdenum. Because zirconium has a thermal neutron cross section that is more than an order of magnitude smaller than steel or molybdenum, it can add more structural integrity without substantially affecting neutron absorption. As another example, a sleeve 70 made of silicon carbide or other carbon-based composites that have quite low neutron absorption cross sections might be used. The backscatter of fast neutrons produced in the fuel salt from the addition of such a backing material would have the added benefit of reducing the peak fast neutron flux at the interface between the neutron moderator material and the calandria tubes 60. This may prolong the neutron moderator lifetime, as this interface at the edge of fuel channels is often the most lifetime limiting (lowest temperature but higher fast flux than deeper into the graphite). The use of the sleeve 70 also creates a double hull arrangement for preventing salt entry into the neutron moderator and serves as a backup if the primary calandria tube barrier is in any way penetrated.

In another embodiment, a beryllium metal could be used for the sleeve 70. As beryllium has a very low neutron absorption cross section and is an excellent neutron moderator, it has been calculated that sleeves of 3 to 10 mm thick backing up calandria tube metal are very effective at bringing down the fast neutron flux impinging upon the neutron moderator (graphite) interface. As much as a one third reduction in fast neutron flux has been found, implying upwards of a one third increase in graphite lifetime. The use of beryllium in a region with high fast neutron flux does result in substantial tritium production. For reactor designs looking to avoid excessive tritium production, this may prove challenging. As well, the swelling characteristics of beryllium metal, which can be as much as 10 to 30% volume swelling at the higher temperatures of reactor usage, would need to be accommodated.

Another embodiment could possibly improve moderator lifetime. The dimensional stability and lifetime of a solid bulk neutron moderator may strongly depend on the temperatures it experiences as it is heated by radiation. Typically, the neutron moderator is only cooled by fuel salt flowing though the tubes (channels). This stability issue is true for both graphite and beryllium. In this embodiment, because the neutron moderator is within a completely sealed calandria, the volume housing the neutron moderator is connected by inlet and outlet piping that can carry into the volume a temperature-reducing fluid or gas (a supplementary coolant or counterforce to external pressure). Such a fluid or gas could include helium or carbon dioxide, which would have almost no effect on neutrons.

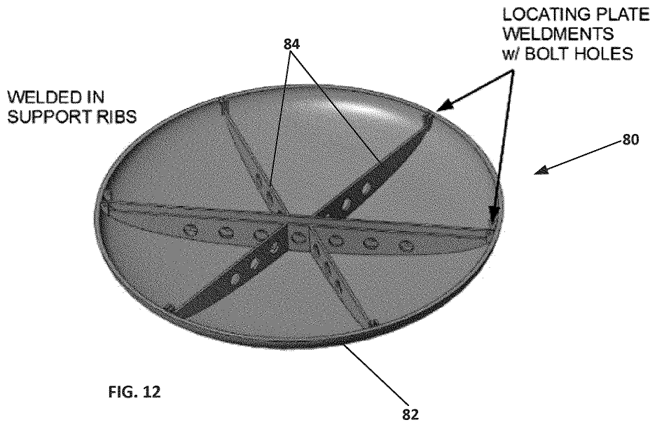

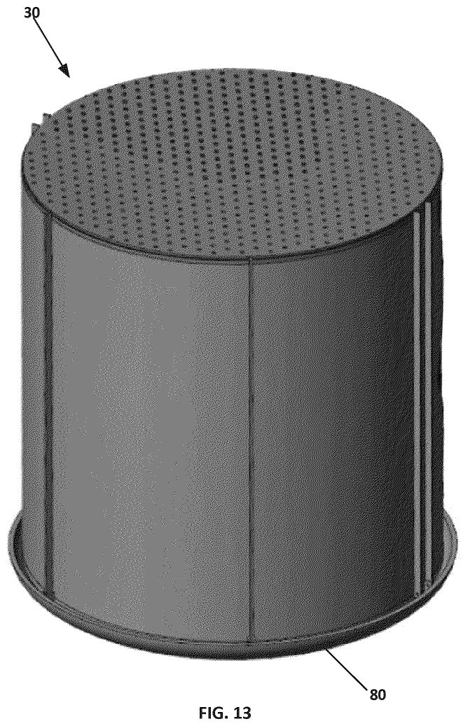

FIG. 12 shows a bottom head assembly 80 that can be secured to the bottom of the calandria 30 shown, for example, in FIG. 7A. The bottom head assembly 80 includes a bottom head 82, which can have any suitable curved profile (e.g., an elliptical profile) and support ribs 84. The support ribs define openings that allow the molten salt to flow across the bottom head 42. FIG. 13 shows the bottom head assembly 30 connected to the calandria 30.

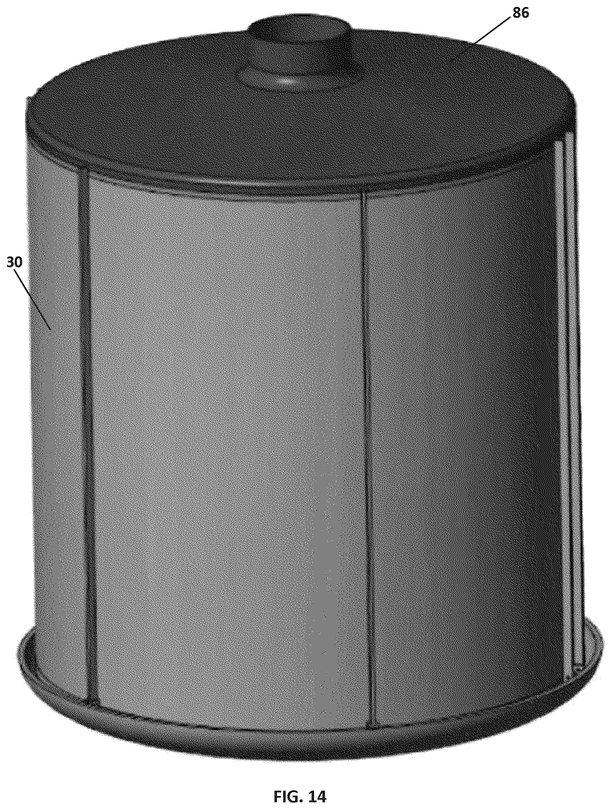

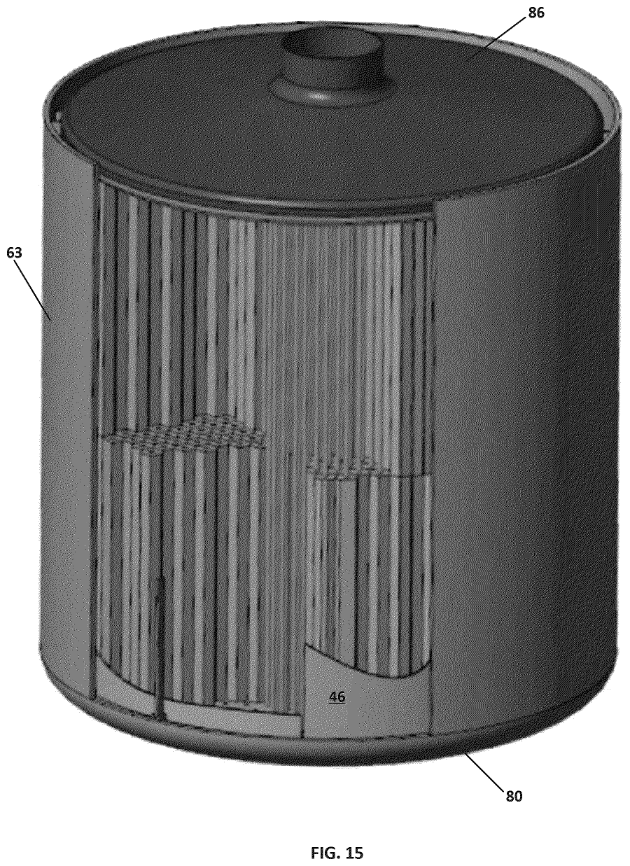

FIG. 14 shows a chimney 86 connected (e.g., welded) to the calandria 30. The chimney 86 guides the molten salt toward a heat exchanger (e.g., the heat exchanger 64 of FIG. 8). FIG. 15 shows a cutaway view of the calandria 30, surrounded by the reactor wall 63.

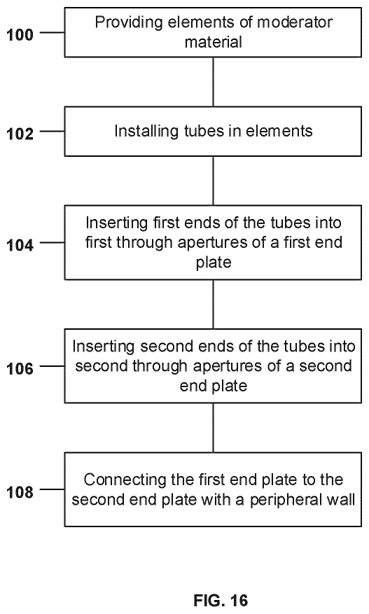

FIG. 16 shows a flowchart of an embodiment of a method according to the present disclosure. The method is for constructing a nuclear reactor core. At step 100, a plurality of elements made of a neutron moderator material is provided. Each neutron moderator element defines at least one through hole. Each neutron moderator element has a first end and a second end, the second end being opposite the first end. Each through hole extends between a respective first end and second end. Each neutron moderator element may, optionally, define additional openings that extend between the respective first end and second end.

At step 102, a plurality of tubes is installed in the through holes of the plurality of neutron moderator elements. Each tube has a first end and a second end. Each first end of the tubes extends out of a respective first end of a neutron moderator element and, each second end of the tubes extends out of a respective second end of a neutron moderator element. Each tube may, optionally, be installed with a sleeve such that the sleeve resides between the tube and the respective neutron moderator element.

At step 104, the first ends of the tubes are inserted into first through apertures of a first end plate. And, at step 106, the second ends of the tubes are inserted into second through apertures of a second end plate. At step 108, the first end plate is connected to the second end plate with a peripheral wall such that the first end plate, second end plate, and peripheral wall form an enclosed space around the plurality of neutron moderator elements.

A vacuum may be optionally applied to the enclosed space to reduce a pressure in the enclosed space. The reduction in pressure causes a reduction in volume of the enclosed space. The reduction in pressure causes the first end plate, the second end plate, the peripheral wall, and the tubes to squeeze against the plurality of neutron moderator elements. A gas may also optionally be pumped into the enclosed space. Further, a particle bed of neutron moderator may be optionally installed in the enclosed space.

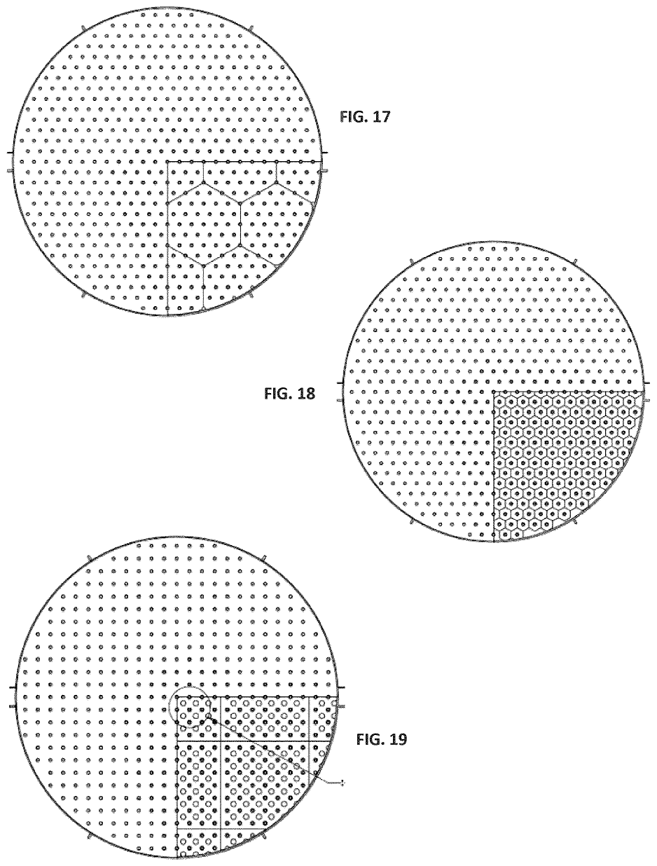

FIGS. 17, 18 and 19 show a top cross-sectional view of neutron moderators logs for hexagonal cross section neutron moderator logs (FIGS. 17 and 18) and for square cross section neutron moderator logs (FIG. 19). The neutron moderator logs of FIGS. 17 and 18 have differing amounts of channels.

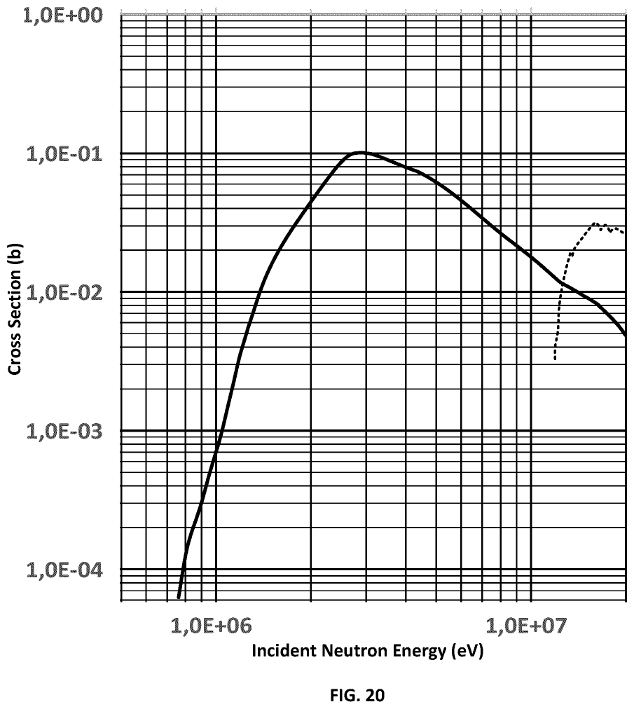

In yet another related embodiment that would provide a solution to the possible high temperatures at midpoints between channels and, at the same time, may improve reactor physics constants would be a calandria employing a cavity at the midpoint between fuel salt channels and having those cavities filled with, for example, beryllium metal or beryllium oxide, either as a solid cylinder and/or as a pebble bed. Beryllium oxide is known to have too low a fast neutron fluence limitation before fracturing for it to be suitable in bulk form. However, as a pebble or powder bed, beryllium oxide could possibly be used. Beryllium metal has a melting point of 1551 K, which could be a limitation, as well as a high degree of swelling. The main innovation here, however, is that by purposefully only employing the element beryllium in a volume with greatly reduced fast neutron fluence, the production of tritium can be significantly reduced. Tritium production from beryllium is due primarily to fast neutrons. There is direct tritium production mainly for fast neutrons above 10 MeV, which is relevant for fusion reactors but is above the energy threshold for fission neutrons. The main fission-produced tritium in beryllium is thus n, alpha reactions (absorbing a neutron and then emitting an alpha particle, i.e. a helium nucleus). This produces ⁶He, which quickly decays to ⁶Li, which has a large cross section for producing tritium. This reaction has only an appreciable cross section above 2 MeV, which is the average energy of fission neutrons. With graphite moderator between the source of fast neutrons and the beryllium, tritium production is dramatically lowered. FIG. 20 shows neutron cross section (barns, b) versus neutron energy (eV) and clearly shows direct tritium production (dash line plot n, t) is only appreciable for the highest fission energies. The n, a (solid line plot, n, alpha) reactions are typically the main source of tritium via the daughter ⁶Li but are only substantial above roughly 2 MeV. Thus, if beryllium is housed in a region of low neutron flux for fast neutrons above 2 MeV, tritium production can be significantly reduced.

The above-described embodiments are intended to be examples only. Alterations, modifications and variations can be effected to the particular embodiments by those of skill in the art without departing from the scope, which is defined solely by the claims appended hereto.

1. A nuclear reactor core comprising:
an annular body (AB) defining a first end and an opposite second end;
a first cover covering the first end and defining a first plurality of through apertures;
a second cover covering the second end and defining a second plurality of through apertures;
a plurality of tubes extending from the first plurality of through apertures to the second plurality of through apertures of the second cover, each tube of the plurality of tubes connecting a through aperture of the first plurality of through apertures to a respective through aperture of the second plurality of through apertures, each tube of the plurality of tubes hermetically sealing an inside volume of each tube from a volume delimited by an outside of each tube of the plurality of tubes, the first cover, the second cover and the annular body, each tube of the plurality of tubes configured to convey a molten fuel salt; and
neutron moderator material located in the AB between the first cover, the second cover and the plurality of tubes.

2. The nuclear reactor core of claim 1, wherein the neutron moderator material defines a plurality of through holes, each tube of the plurality of tubes extending through a respective through hole of the plurality of through holes.

3. The nuclear reactor core of claim 1, wherein the neutron moderator material is in a form of a plurality of solid bulk neutron moderator elements (NMEs).

4. The nuclear reactor core of claim 3, wherein each NME of the plurality of NMEs defines at least one through hole extending from a first end of the respective NME to a second end of the respective NME, each tube of the plurality of tubes extending through a respective one of the at least one through hole.

5. The nuclear reactor core of claim 4, wherein each NME of the plurality of NMEs defines one or more through openings distinct and spaced apart from the plurality of through holes, each of the one or more through openings being free of any tube of the plurality of tubes extending therethrough.

6. The nuclear reactor core of claim 5, wherein each of the one or more through openings are formed equidistant between two or more through holes.

7. The nuclear reactor core of claim 5, wherein each through opening of the one or more through openings is at least partially filled with a particle bed of neutron moderator material.

8. The nuclear reactor core of claim 7, wherein each through opening of the one or more through openings is at least partially filled with another moderator material different from the neutron moderator material of the plurality of NMEs.

9. The nuclear reactor core of claim 7, wherein the particle bed of neutron moderator material includes at least one of a powder, pebbles, flakes and grindings of the neutron moderator material.

10. The nuclear reactor core of claim 8, wherein the particle bed of the other neutron moderator material includes at least one of a powder, pebbles, flakes and grindings of the other neutron moderator material.

11. The nuclear reactor core of claim 1, wherein the neutron moderator material is in a form of a particle bed.

12. The nuclear reactor core of claim 11, wherein the particle bed includes at least one of a powder, pebbles, flakes and grindings of the neutron moderator material.

13. The nuclear reactor core of claim 1, wherein the neutron moderator material is in a form of a liquid.

14. The nuclear reactor core of claim 13, wherein the neutron moderator material being in the form of a liquid is a fluoride salt containing beryllium fluoride.

15. The nuclear reactor core of claim 1, wherein the volume delimited by an outside of each tube of the plurality of tubes, the first cover, the second cover and the annular body, is positively pressurized.

16. The nuclear reactor core of claim 1, wherein:
the annular body (AB) defines an AB wall with an AB wall thickness,
the first cover has a first cover thickness,
the second cover has a second cover thickness,
the plurality of tubes have a tube thickness, and
the AB wall thickness, the first cover thickness, the second cover thickness and the tube thickness are selected for the AB, the first cover, the second cover and the tubes to conform at least partially to the neutron moderator material when the volume delimited by the outside of each tube of the plurality of tubes, the first cover, the second cover and the annular body is negatively pressurized to a threshold pressure.

17. The nuclear reactor core of claim 1, wherein:
the annular body (AB) defines an AB wall that has a wall with an AB wall thickness,
the first cover has a first cover thickness,
the second cover has a second cover thickness,
the plurality of tubes have a tube thickness, and
the AB wall thickness, the first cover thickness, the second cover thickness and the tube thickness are selected for the AB, the first cover, the second cover and the tubes to provide structural integrity to the nuclear reactor core.

18. The nuclear reactor core of claim 16, wherein the tube thickness is comprised between 0.2 and 1 mm.

19. The nuclear reactor core of claim 17, wherein the tube thickness is comprised between 0.5 and 3 mm.

20. The nuclear reactor core of claim 1, wherein each of the tubes of the plurality of tubes comprises bellows configured to expand and contract.

21. The nuclear reactor core of claim 1, further comprising a plurality of sleeves, each sleeve housing and supporting a respective tube of the plurality of tubes.

22. The nuclear reactor core of claim 21, wherein the sleeve is made of material that has a neutron absorption cross section smaller than 1 barn.

23. The nuclear reactor core of claim 22, wherein the material is selected from a group consisting of zirconium metal, zirconium alloys, silicon carbide, carbon-based composites, and beryllium metal.

24. The nuclear reactor core of claim 1, wherein the neutron moderator material is graphite.

25. The nuclear reactor core of claim 10, wherein the particle bed of the other neutron moderator material is made from beryllium oxide.

26. The nuclear reactor core of claim 1, wherein the AB, the first cover, the second cover and the plurality of tubes are made of a material selected from a group consisting of stainless steel, molybdenum, TZM, Alloy N, silicon carbide and carbon-based composites.

27. A calandria nuclear core assembly comprising:
a plurality of neutron moderator elements, each neutron moderator element (NME) having a first end and a second end, each NME defining a through hole extending from the first end to the second end, along an entire length of the NME;
a plurality of tubes, each tube being located in a respective NME, each tube having a first end portion and a second end portion, the first end portion protruding out of the first end of the respective NME, the second end portion protruding out of the second end of the respective NME;
a first plate defining a respective plurality of through apertures;
a second plate defining a respective plurality of through apertures;
the first end portion of each tube being inserted into a respective through aperture of the first plate; the second end portion of each tube being inserted into a respective through aperture of the second plate; and
a peripheral wall surrounding the NMEs and connecting the first plate to the second plate;
wherein:
any space between an outside of the first end portion of the tubes and the respective through aperture of the first plate is sealed;
any space between an outside of the second end portion of the tubes and the respective through aperture of the second plate is sealed;
the peripheral wall forms a seal with the first plate and with the second plate.

28. The calandria nuclear core assembly of claim 27, wherein each tube has an outside portion and a volume defined by the outside of the tubes, the first plate, the second plate and the peripheral wall is negatively pressurized.

29. A method of assembling a nuclear moderator core system, the method comprising:
providing a plurality of neutron moderator elements, each neutron moderator element (NME) defining a through hole, each NME having a first end and a second end, the second end being opposite the first end, each through hole extending between a respective first end and second end;
installing a plurality of tubes in the plurality of NMEs by having each tube pass through a respective through hole defined by a NME, each tube of the plurality of tubes having a first end and a second end, wherein when the plurality of tubes are installed, each first end of a tube extends out of a respective first end of a respective NME and each second end of the tube extends out of a respective second end of the respective NME;
inserting the plurality of first ends of tubes into through apertures of a first end plate and securing the plurality of first ends of the tubes to the first end plate;
inserting the plurality of second ends of tubes into through apertures of a second end plate and securing the plurality of second ends of the tubes to the second end plate;
connecting the first end plate to the second end plate with a peripheral wall that surrounds the plurality of NMEs, the peripheral wall, the first end plate, the second end plate and the outer surface of the plurality of tubes defining an enclosed space; and
applying a vacuum to the enclosed space to reduce a pressure in the enclosed space, a reduction in pressure to cause the first end plate, the second end plate and the tubes to squeeze against the plurality of NMEs.
